(19) United States
(12) Patent Application Publication
(10) Pub. No.: US 2025/0238298 A1
(43) Pub. Date: Jul. 24, 2025

(54) CORRECTABLE ERROR COUNTER AND LEAKY BUCKET FOR PERIPHERAL COMPONENT INTERCONNECT EXPRESS (PCIE) AND COMPUTE EXPRESS LINK (CXL) DEVICES

(71) Applicant: Intel Corporation, Santa Clara, CA (US)

(72) Inventors: Changpeng Guo, KunShan (CN); Tao Xu, Shanghai (CN); Xiaolei Guo, Shanghai (CN)

(73) Assignee: Intel Corporation, Santa Clara, CA (US)

(21) Appl. No.: 18/853,475

(22) PCT Filed: May 25, 2022
(86) PCT No.: PCT/CN2022/094857

§ 371 Date: Oct. 2, 2024

(51) Int. Cl. G06F 11/07

(52) U.S. Cl. CPC G06F 11/076; G06F 11/0745; G06F 11/0757; G06F 2201/81

(57) ABSTRACT

Embodiments described herein are generally directed to a software CE counter and leaky bucket for PCIe and CXL devices. In an example, when a burst of CEs exceeding an error threshold is reported by a PCIe or CXL device associated with a computer system, CE reporting for the device is disabled and a notification is issued to the BMC. Responsive to receipt of the notification, the BMC performs threshold-based error rate monitoring. An error counter is decremented by the BMC in accordance with a leak rate of a leaky bucket implemented by the BMC for the device. During periodic error monitoring performed by the BMC for new CEs logged by the device, the error counter is incremented when a new correctable error has been logged by the device since a prior error monitoring interval. Based on the error counter, the BMC distinguishes between persistent and temporal errors of the device.

### TECHNICAL FIELD

Embodiments described herein generally relate to the field of correctable error reporting and PCIe and CXL devices. More particularly, embodiments relate to a software implementation of a correctable error counter and leaky bucket for PCIe and CXL devices.

### BACKGROUND

A PCIe receiver (e.g., a component inside a PCIe device) could observe a burst of large number of correctable errors (CEs) owing to various PCIe physical layer rules, e.g. 128/130 b or 8/10 b encoding, packet framing, elastic buffer or symbol lock and lane deskew loss, as well as data link layer packet (DLLP)/transaction layer packet (TLP) cyclical redundancy check (CRC) failure errors. Due to the correctable nature of the CEs, platform software of a computer system with which the PCIe device is associated has no need to respond to each reported CE.

### BRIEF DESCRIPTION OF THE DRAWINGS

Embodiments described here are illustrated by way of example, and not by way of limitation, in the figures of the accompanying drawings in which like reference numerals refer to similar elements.

FIG. 1 is a block diagram illustrating hardware and software components of a computer system involved in handling PCIe or CXL device correctable error reporting according to some embodiments.

FIG. 2 is a flow diagram illustrating a set of operations for performing SMI error handling according to some embodiments.

FIG. 3 is a flow diagram illustrating a set of operations for implementing a leaky bucket event handler according to some embodiments.

FIG. 4 is a flow diagram illustrating a set of operations for handling expiration of a leak timer according to some embodiments.

FIG. 5 is a flow diagram illustrating a set of operations for handling expiration of an error monitor timer according to some embodiments.

FIG. 6 is an example of a computer system in which some embodiments may be employed.

### DETAILED DESCRIPTION

Embodiments described herein are generally directed to a software CE counter and leaky bucket for PCIe and CXL devices. There is no hardware logic that implements an error counter or a leaky bucket on PCIE/CXL devices. Neither the PCIe nor the CXL specifications define a mechanism to count CEs and/or inspect the error rate on PCIe/CXL devices. Traditional behavior of a PCIe/CXL device is to report every CE to the root complex to which the PCIe/CXL device is connected. When signaling via System Management Interrupt (SMI) is configured within the root complex responsive to receipt of reporting of a CE by a PCIe/CXL device, then every such CE triggers an SMI to be handled by an SMI handler within the basis input/output system (BIOS) of the host system. However, platform software usually does not have a need to keep track of every CE. In fact, if there is a marginal link associated with the PCIe/CXL device, then excessive CEs would be detected and reported by the PCIe/CXL device resulting in an SMI storm. Since SMIs are high priority unmaskable hardware interrupts that cause the CPU to immediately suspend all other activities, including the operating system, and enter a special execution mode called system management mode (SMM), SMI storms may lead to performance degradation of the host system. Unfortunately, however, as PCIe/CXL devices have no internal mechanism to count CEs and/or allow for inspection of the error rate on the PCIe/CXL devices, and CE reporting represents the only indicator of the health of the PCIe link, software developers and system administrators are placed in a tough situation. For example, a system administrator may not wish to report CEs for every occurrence, but rather may desire to report the CEs at a specified error rate. As such, they are faced with the tradeoff of (i) attempting to keep track of CEs but having to accept the potential for system performance degradation resulting from SMI storms triggered by a persistent CE or (ii) disabling SMI for CEs reported by PCIe/CXL devices to avoid SMI storms but being left without any insight into the health of a given PCIe link. Neither of which are acceptable. Without an acceptable way to measure the frequency of CEs to profile the integrity of a PCIe link and predict the potential for non-fatal and fatal errors an operating system cannot take proactive action to prevent severe system damage and/or data loss.

In view of the foregoing, embodiments described herein seek to provide a software CE counter and leaky bucket for PCIe and CXL devices. For example, in one embodiment, when a burst of CEs are reported by a PCIe or CXL device to a processor of a computer system in which the CEs exceed an error threshold, CE reporting by the PCIe or CXL device may be disabled and a notification may be issued to a baseboard management controller (BMC) of the computer system. In response to receipt of the notification, the BMC may perform threshold-based error rate monitoring, including (i) decrementing an error counter in accordance with a leak rate of a leaky bucket implemented by the BMC for the PCIe or CXL device; (ii) during periodic error monitoring for new correctable errors logged by the PCIe or CXL device, incrementing the error counter when a new correctable error has been logged by the device since a prior error monitoring interval; and (iii) distinguishing between persistent and temporal errors associated with the PCIe or CXL device based on the error counter. Advantageously, in this manner, SMI storms may be avoided due to PCIe/CXL CE reporting bursts and a threshold-based, error rate monitored CE reporting mechanism for all PCIE/CXL devices is provided, thereby facilitating, among other things, more precise reporting of PCIe/CXL CEs, generation of notifications to the operating system of CEs at a desired rate, and profiling the integrity of PCIe links to allow prediction of a system crisis before it happens.

In the following description, numerous specific details are set forth in order to provide a thorough understanding of example embodiments. It will be apparent, however, to one skilled in the art that embodiments described herein may be practiced without some of these specific details.

### Terminology

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

If it is said that an element “A” is coupled to or with element “B,” element A may be directly coupled to element B or be indirectly coupled through, for example, element C. When the specification or claims state that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.”

An “embodiment” is intended to refer to an implementation or example. Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. It should be appreciated that in the foregoing description of exemplary embodiments, various features are sometimes grouped together in a single embodiment, figure, or description thereof for the purpose of streamlining the disclosure and aiding in the understanding of one or more of the various novel aspects. This method of disclosure, however, is not to be interpreted as reflecting an intention that the claimed embodiments requires more features than are expressly recited in each claim. Rather, as the following claims reflect, novel aspects lie in less than all features of a single foregoing disclosed embodiment. Thus, the claims are hereby expressly incorporated into this description, with each claim standing on its own as a separate embodiment.

As used herein a “leaky bucket algorithm” or simply a “leaky bucket” generally refers to an algorithm based on an analogy of how a bucket with a constant leak will overflow if either the average rate at which water is poured in exceeds the rate at which the bucket leaks or if more water than the capacity of the bucket is poured in all at once. The leaky bucket algorithm is generally used to determine whether some sequence of discrete events conforms to defined limits on their average and peak rates or frequencies, for example, to limit the actions associated with these events to these rates or delay them until they do conform to the rates. In the context of various examples described herein, the leaky bucket limits the rate at which CEs reported by individual PCIe/CXL devices associated with a computer system trigger SMIs within the computer system so as to protect against degradation of performance by the computer system.

### Example Operating Environment

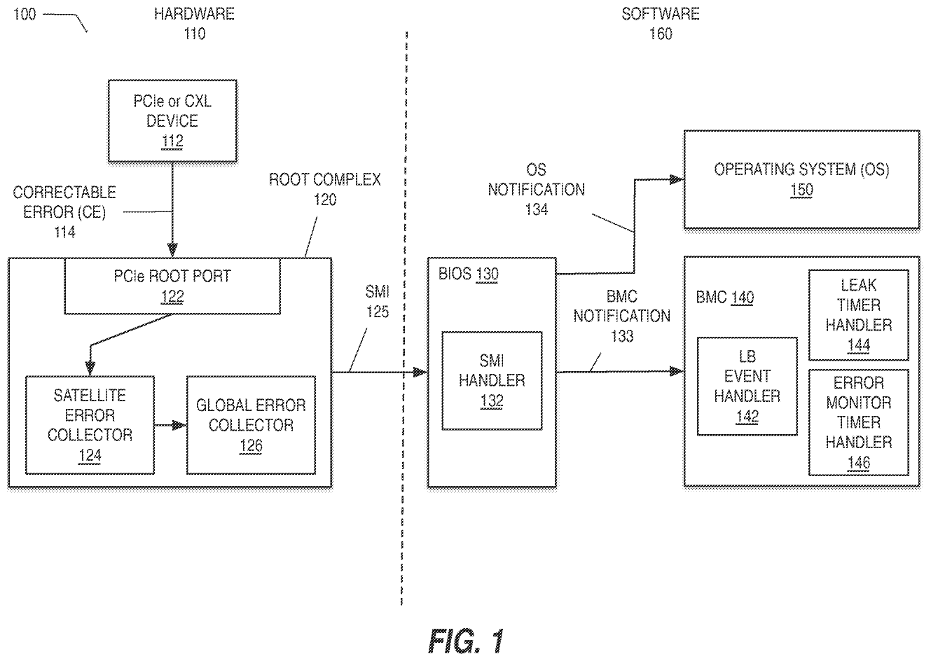

FIG. 1 is a block diagram illustrating hardware 110 and software 160 components of a computer system 100 involved in handling PCIe or CXL device correctable error reporting according to some embodiments. In the context of the present example, the hardware components include an integrated or dedicated PCIe or CXL device 112 (or “endpoint”) and a root complex 120. When the PCIe or CXL device 112 generates a CE 114, the CE is routed through the root complex 120, for example, via a satellite error collector (not shown) and a global error collector (not shown), which signals an SMI 125. Depending upon the configuration of the computer system 100, the PCIe or CXL device 112 may represent a graphics processing unit (GPU), a network interface card, a storage accelerator device, and/or another type of high-performance peripheral.

On the software 160 side, an SMI handler 132 of a BIOS 130 may probe the error and trigger an error handling mechanism of an operating system (OS) 150. For example, in the context of the Windows OS, the SMI handler 143 may create a Windows Hardware Error Architecture (WHEA) error log, and notify the OS 150 via an OS notification 134 by signaling an SMI. At this point, the OS 150 may retrieve the log and show it in its event log list. As noted above, at present when signaling via SMI is configured within the root complex 120 responsive to receipt of reporting of a CE (e.g., CE 114) by PCIe/CXL devices (e.g., PCIe or CXL device 112), every such CE triggers an SMI to be handled by the SMI handler 132. As also noted above, because SMIs cause the OS 150 to enter into SMM, an SMI storm resulting from excessive CEs may lead to performance degradation of the computer system 100.

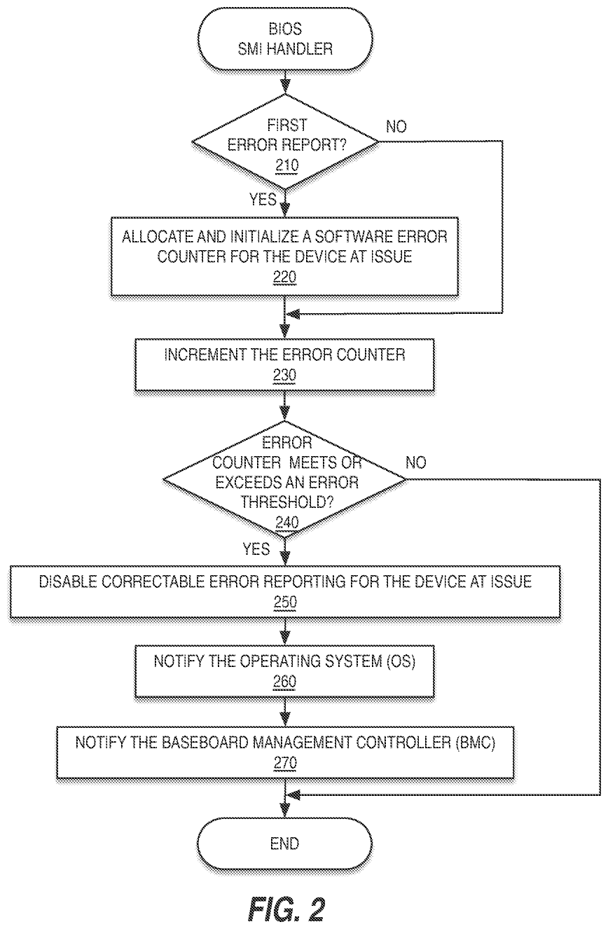

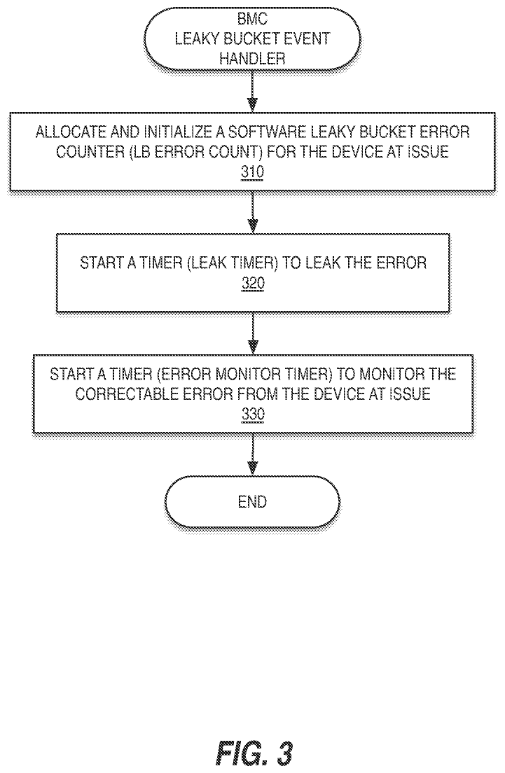

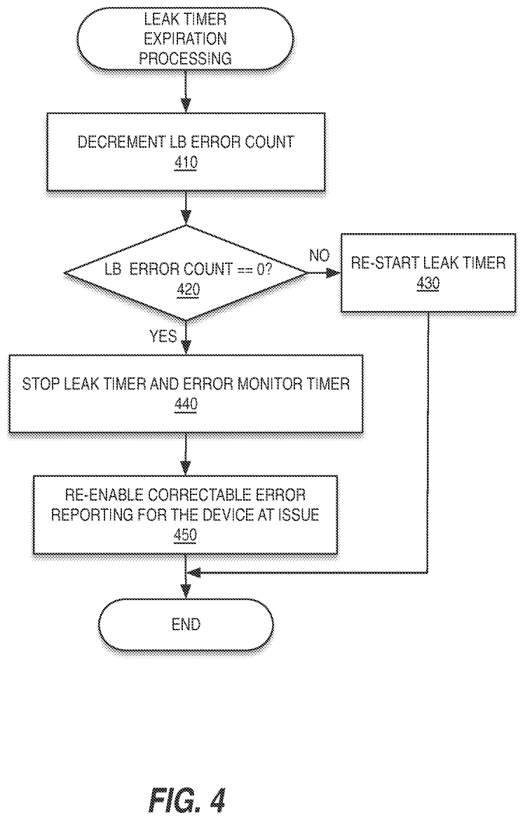

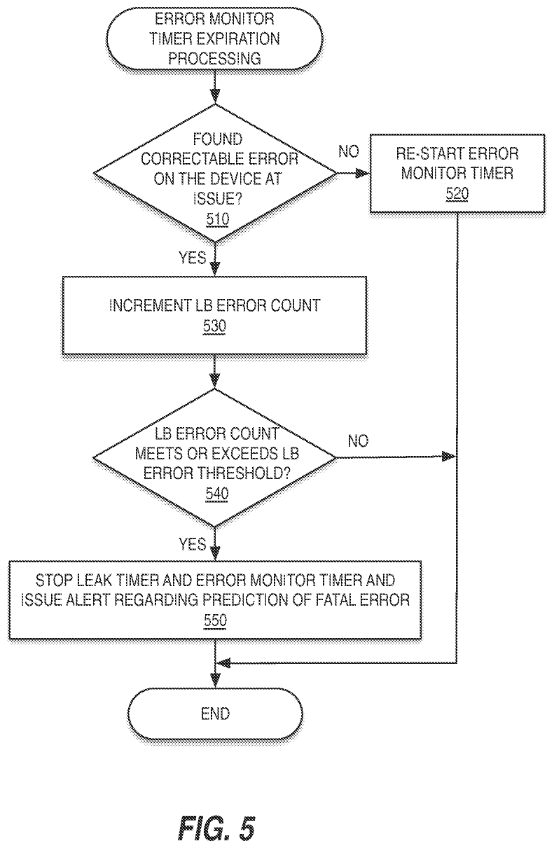

As described further below with reference to FIG. 2, responsive to CE reporting by a particular PCIe/CXL device (e.g., PCIe or CXL device 112) hitting a threshold, the adverse effects of excessive CE reporting by the particular PCIe/CXL on performance of the computer system 100 may be mitigated by the SMI handler 132 by temporarily disabling CE reporting by the particular PCIe/CXL device. Additionally, responsive to a notification (e.g., BMC notification 133) from the SMI handler 132 to a BMC 140 of the computer system 100, a leaky bucket (LB) event handler 142 running within the BMC 140 may establish a software LB error counter for the particular PCIe/CXL device and kick off an error monitor timer to monitor for new CEs that come in from the particular PCIe or CXL device 112 and a leak timer to leak the CEs at a desired rate as described further below with reference to FIG. 3. Expiration of the error monitor timer may be handled by an error monitor timer handler 146 and expiration of the leak timer may be handled by a leak timer handler 144. When the LB error counter for the particular PCIe/CXL device has been leaked to zero, the BMC 140 may re-enable CE reporting. In this manner, the error monitoring interval may be established to facilitate distinguishing between a temporary issue and a persistent issue being experienced by the particular PCIe/CXL device. In one embodiment, the error monitor timer and the leak timer may be configured according to the reality of the hardware design. Examples of processing performed responsive to expiration of the leak timer and the error monitor timer that may be performed by the leak timer handler 144 and the error monitor timer handler 146, respectively, are described below with reference to FIGS. 4 and 5.

### Example SMI Error Handling

FIG. 2 is a flow diagram illustrating a set of operations for performing SMI error handling according to some embodiments. The processing described with reference to FIG. 2 may be performed by an SMI handler (e.g., SMI handler 132) representing a portion of firmware of a BIOS (e.g., BIOS 130) of a computer system (e.g., computer system 100) that provides run-time services for an operating system (e.g., OS 150) of the computer system. The SMI handler may be triggered by an SMI (e.g., SMI 125) resulting from a CE (e.g., CE 114) reported by a particular PCIe/CXL device (e.g., PCIe or CXL device 112). In the context of the present example, it is assumed prior to the error handling, which happens during runtime (e.g., the OS is running), an error threshold (e.g., one for all PCI/CXL devices or one for each PCI/CXL device) has been established during a PCIe/CXL error reporting initialization phase, which may be during boot time or during BIOS execution time.

At decision block 210, it is determined whether the SMI triggering the SMI handler is as a result of a first error report by the particular PCIe/CXL device. If so, processing continues with block 220; otherwise, processing branches to block 230. A first error report may represent an initial error report by the particular PCIe/CXL device since startup of the computer system or may represent an initial error report after CE reporting for the particular PCIe/CXL device has been re-enabled.

At block 220, a software error counter is allocated and initialized for the particular PCIe/CXL device. In one embodiment, a data structure may be maintained for tracking error counters for each PCIe/CXL device associated with the computer system, for example, based on their respective hardware identifiers (IDs).

At block 230, the error counter for the particular PCIe/CXL device that originated the CE is incremented.

At decision block 240, a determination is made regarding whether the error counter meets or exceeds the error threshold. If so, processing continues with block 250; otherwise, SMI error handling processing is complete.

At block 250, CE reporting for the particular PCIe/CXL device is disabled. For example, an advanced error reporting (AER) field, bit, of flag within a device control register of the PCIe/CXL device may be set to a disabled state.

At block 260, the OS is notified of the CE. For example, an SMI may be signaled to generate an OS notification (e.g., OS notification 134).

At block 270, the BMC may also be notified of the CE, for example, via BMC notification 133.

While in the context of the present example, a number of enumerated blocks are included, it is to be understood that the examples may include additional blocks before, after, and/or in between the enumerated blocks. Similarly, in some examples, one or more of the enumerated blocks may be omitted or performed in a different order.

### Example Leaky Bucket Event Handler

FIG. 3 is a flow diagram illustrating a set of operations for implementing a leaky bucket event handler according to some embodiments. The processing described with reference to FIG. 3 may be performed by an LB event handler (e.g., LB event handler 142) operable within a BMC (e.g., BMC 140) of a computer system (e.g., computer system 100). The LB event handler may be triggered responsive to an BMC notification (e.g., BMC notification 133) originated by an SMI handler (e.g., SMI handler 132) operable within a BIOS (e.g., BIOS 130) of the computer system. The SMI handler, for its part, may have been triggered by an SMI (e.g., SMI 125) resulting from a CE (e.g., CE 114) reported by a particular PCIe/CXL device (e.g., PCIe or CXL device 112) associated with the computer system.

At block 310, a software LB error counter (which may be referred to as “LB error count” herein) is allocated and initialized for the particular PCIe/CXL device.

At block 320, a timer is started to leak the error. For convenience of reference, this timer may be referred to as the “leak timer” herein. The leak timer should be configurable. There are multiple aspects that may be taken into consideration in connection with determining the leak timer interval for the particular PCIe/CXL device, for example, the nature of the workloads of the particular PCIe/CXL device, the impact of a potential non-fatal/fatal error happening on the particular PCIe/CXL device, the hardware signal stability, and/or the like. Based on such considerations, the CE could be leaked at a desired rate (e.g., in terms of minutes, hours or days). For example, a long-lived workload is suggestive of a longer leak period as the CE could happen frequently, the criticality of the particular PCIe/CXL device is also suggestive of use of a longer leak period to predict the error more sensitively, a bad hardware signal could cause CE more frequently, which suggests the use of a shorter leak period to leak the error fast as a way to work around this.

At block 330, a timer is started to monitor the CEs from the particular PCIe/CXL device. For convenience of reference, this timer may be referred to as the “error monitor timer” timer” herein. Like the leak timer, the error monitor timer should be configurable. There are multiple aspects that may be taken into considered in connection with determining the error monitor timer interval, for example, the nature of the workloads of the particular PCIe/CXL device, the impact of a potential non-fatal/fatal error happening on the particular PCIe/CXL device, the hardware signal stability, and/or the like. Based on such considerations, the error monitoring interval may be established at the desired rate (e.g., in terms of milliseconds (ms) or minutes). For example, a higher monitoring rate (shorter error monitor timer) would likely be used for more critical tasks, a lower monitoring rate (longer error monitor timer) may be used to work around hardware signal instability, and unstable, and the lower monitoring rate (longer error monitor timer) may be used for a PCIe/CXL device expected to have a heavy workload as this could result in the generation of CEs more frequently.

While in the context of the present example, a number of enumerated blocks are included, it is to be understood that the examples may include additional blocks before, after, and/or in between the enumerated blocks. Similarly, in some examples, one or more of the enumerated blocks may be omitted or performed in a different order.

### Example Leak Timer Processing

FIG. 4 is a flow diagram illustrating a set of operations for handling expiration of a leak timer according to some embodiments. The processing described with reference to FIG. 4 may be performed by a leak timer handler (e.g., leak timer handler 144) operable within a BMC (e.g., BMC 140) of a computer system (e.g., computer system 100) responsive to expiration of a leak timer (e.g., the leak timer started in block 320 of FIG. 3) for a particular PCIe/CXL device (e.g., PCIe or CXL device 112) associated with the computer system.

At block 410, the LB error count for the particular PCIe/CXL device is decremented.

At decision block 420, it is determined whether the LB error count is equal to zero. If so, processing continues with block 440; otherwise, processing branches to block 430. In the context of the present example, the LB error count will reach zero when CEs (e.g., CE 114) associated with the spike detected at decision block 240 of FIG. 2 and for which reporting has been disabled at block 250 of FIG. 2 represents a temporary issue rather than a persistent one based on the configuration of the LB error count, the leak timer, and the error monitor timer.

At block 440, the leak timer and the error monitor timer are stopped.

Since the LB error count has reached zero, the CEs logged by the particular PCIe/CXL device and monitored by the BMC, for example, by an error monitor timer handler (e.g., error monitor timer handler 146) are occurring at a rate lower than the rate at which they are leaked by the leak timer. In the context of the present, the LB error count reaching zero is presumably indicative of the rate at which CEs are occurring is an acceptable rate for CE reporting to resume. As such, at block 450, CE reporting is re-enabled for the particular PCIe/CXL device.

At block 430, the leak timer is re-started to continue to leak the errors and leak timer expiration processing is complete for this leak timer interval. In this manner, while the LB error count remains greater than zero, CE reporting for the particular PCIe/CXL device will remain disabled and the errors will continue to be leaked at the rate established collectively by the LB error count, the leak timer, and the error monitor timer.

While in the context of the present example, a number of enumerated blocks are included, it is to be understood that the examples may include additional blocks before, after, and/or in between the enumerated blocks. Similarly, in some examples, one or more of the enumerated blocks may be omitted or performed in a different order.

### Example Error Monitor Timer Processing

FIG. 5 is a flow diagram illustrating a set of operations for handling expiration of an error monitor timer according to some embodiments. The processing described with reference to FIG. 5 may be performed by an error monitor timer handler (e.g., error monitor timer handler 146) operable within a BMC (e.g., BMC 140) of a computer system (e.g., computer system 100) responsive to expiration of an error monitor timer (e.g., the error monitor timer started in block 330 of FIG. 3) for a particular PCIe/CXL device (e.g., PCIe or CXL device 112) associated with the computer system.

At decision block 510, a determination is made regarding whether a CE has been logged by the particular PCIe/CXL device since the last error monitoring cycle. If so, processing continues with block 530; otherwise processing branches to block 520.

At block 520, the error monitor timer is re-started to start a new error monitoring interval and error monitor timer expiration processing is complete for this error monitoring interval.

At block 530, the LB error count is incremented to reflect the occurrence of a new CE associated with the particular PCIe/CXL device.

At decision block 540, a determination is made regarding whether the LB error count meets or exceeds an LB error threshold. If so, processing continues with block 550; otherwise, error monitor timer expiration processing is complete for this error monitoring interval. The LB error threshold should be configurable. There are multiple aspects that may be taken into considered in connection with determining the LB error threshold for a particular PCIe/CXL device, for example, the nature of the workloads of the particular PCIe/CXL device, the impact of a potential non-fatal/fatal error happening on the particular PCIe/CXL device, the hardware signal stability, and/or the like. Based on such considerations, the LB error threshold could range from hundreds to thousands. For example, the LB error threshold may be set lower for more critical tasks, higher to work around hardware signal instability, and higher to accommodate heavy workloads so as to accommodate more frequent generation of CEs.

At block 550, the leak timer and the error monitor timer are stopped and an alert may be issued to a system administrator regarding prediction of a fatal error associated with the particular PCIe/CXL device.

While in the context of the present example, a number of enumerated blocks are included, it is to be understood that the examples may include additional blocks before, after, and/or in between the enumerated blocks. Similarly, in some examples, one or more of the enumerated blocks may be omitted or performed in a different order.

### Example Computer System

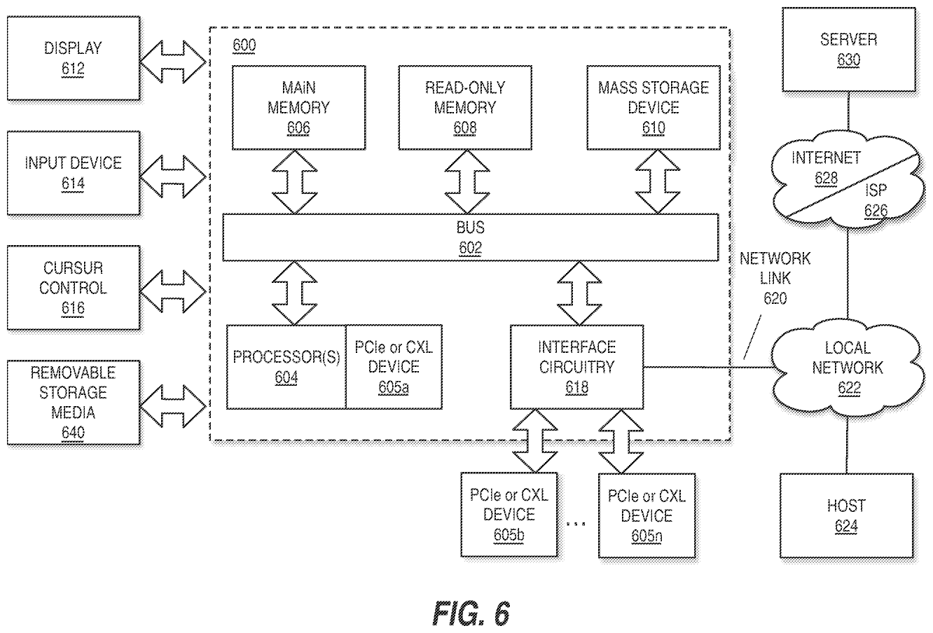

FIG. 6 is an example of a computer system 600 in which some embodiments may be employed. For example, computer system 600 may represent an example of computer system 100 of FIG. 1. Notably, components of computer system 600 described herein are meant only to exemplify various possibilities. In no way should example computer system 600 limit the scope of the present disclosure. In the context of the present example, computer system 600 includes a bus 602 or other communication mechanism for communicating information, and a processing resource (e.g., one or more hardware processors 604) coupled with bus 602 for processing information.

Computer system 600 also includes a main memory 606, such as a random-access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, e.g., a magnetic disk, optical disk or flash disk (made of flash memory chips), is provided and coupled to bus 602 for storing information and instructions.

Computer system 600 may be coupled via bus 602 to a display 612, e.g., a cathode ray tube (CRT), Liquid Crystal Display (LCD), Organic Light-Emitting Diode Display (OLED), Digital Light Processing Display (DLP) or the like, for displaying information to a computer user. An input device 614, including alphanumeric and other keys, is coupled to bus 602 for communicating information and command selections to processor 604. Another type of user input device is cursor control 616, such as a mouse, a trackball, a trackpad, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Removable storage media 640 can be any kind of external storage media, including, but not limited to, hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM), USB flash drives and the like.

Computer system 600 may implement the techniques described herein using customized hard-wired logic, one or more ASICs or FPGAs, firmware or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data or instructions that cause a machine to operation in a specific fashion. Such storage media may comprise non-volatile media or volatile media. Non-volatile media includes, for example, optical, magnetic or flash disks, such as storage device 610. Volatile media includes dynamic memory, such as main memory 606. Common forms of storage media include, for example, a flexible disk, a hard disk, a solid-state drive, a magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid-state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes interface circuitry 618 coupled to bus 602. The interface circuitry 618 may be implemented by hardware in accordance with any type of interface standard, such as an Ethernet interface, a universal serial bus (USB) interface, a Bluetooth® interface, a near field communication (NFC) interface, a PCI interface, and/or a PCIe interface. As such, interface 618 may couple the processing resource in communication with one or more discrete PCIe or CXL devices 605b-n. Alternatively or additionally computer system 600 may include one or more integrated PCIe or CXL devices (e.g., PCIe or CXL devices 605a). PCIe or CXL devices 605a-n may be analogous to PCIe or CXL device 112 of FIG. 1.

Additionally or alternatively, interface 618 may also provide a two-way data communication coupling to a network link 620 that is connected to a local network 622. For example, interface 618 may be an integrated services digital network (ISDN) card, cable modem, satellite modem, or a modem to provide a data communication connection to a corresponding type of telephone line. As another example, interface 618 may be a local area network (LAN) card to provide a data communication connection to a compatible LAN. Wireless links may also be implemented. In any such implementation, interface 618 may send and receive electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the worldwide packet data communication network now commonly referred to as the “Internet” 628. Local network 622 and Internet 628 both use electrical, electromagnetic or optical signals that carry digital data streams. The signals through the various networks and the signals on network link 620 and through interface 618, which carry the digital data to and from computer system 600, are example forms of transmission media.

Computer system 600 can send messages and receive data, including program code, through the network(s), network link 620 and interface 618. In the Internet example, a server 630 might transmit a requested code for an application program through Internet 628, ISP 626, local network 622 and interface 618. The received code may be executed by processor 604 as it is received, or stored in storage device 610, or other non-volatile storage for later execution.

Many of the methods may be described in their most basic form, but processes can be added to or deleted from any of the methods and information can be added or subtracted from any of the described messages without departing from the basic scope of the present embodiments. It will be apparent to those skilled in the art that many further modifications and adaptations can be made. The particular embodiments are not provided to limit the concept but to illustrate it. The scope of the embodiments is not to be determined by the specific examples provided above but only by the claims below.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to perform acts of the method, or of an apparatus or system for facilitating hybrid communication according to embodiments and examples described herein.

Some embodiments pertain to Example 1 that include a computer system comprising: a processor; a baseband management controller (BMC) coupled to the processor; and a machine-readable medium, coupled to the processor, having stored therein instructions, which when executed by the processor cause the computer system to responsive to a burst of correctable errors reported by a device exceeding an error threshold: disable correctable error reporting for the device, wherein the device comprises a peripheral component interconnect express (PCIe) or a compute express link (CXL) device associated with the computer system; and cause the BMC to perform threshold-based error rate monitoring by issuing a notification to the BMC, wherein the threshold-based error rate monitoring, includes: during periodic error monitoring keeping track of when a correctable error has been logged by the device; and distinguishing between persistent and temporal errors associated with the device based on the correctable errors.

Example 2 includes the subject matter of Example 1, wherein the threshold-based error rate monitoring further includes: decrementing an error counter in accordance with a leak rate of a leaky bucket implemented by the BMC for the device; and during periodic error monitoring for new correctable errors logged by the device, incrementing the error counter when a new correctable error has been logged by the device since a prior error monitoring interval.

Example 3 includes the subject matter of Examples 1-2, wherein the instructions further cause the computer system to responsive to the error counter exceeding a persistent error threshold, identify existence of a persistent error associated with the device.

Example 4 includes the subject matter of Examples 1-3, wherein the persistent error is predictive of an imminent uncorrectable error associated with the device.

Example 5 includes the subject matter of Examples 1-4, wherein the instructions further cause the computer system to responsive to the error counter falling to zero: identify the burst of correctable errors as the temporal error; and re-enable correctable error reporting for the device.

Example 6 includes the subject matter of Examples 1-5, wherein the burst of correctable errors are individually reported to a system management interrupt (SMI) handler of a basic input/output system (BIOS) running on the processor and wherein the instructions further cause the computer system to protect, by the SMI handler, against degradation of performance of the processor by said disabling correctable error reporting for the device.

Example 7 includes the subject matter of Examples 1-6, wherein the instructions further cause the computer system to limit notifications to an operating system of the computer system regarding correctable errors reported by the device to a desired notification rate.

Example 8 includes the subject matter of Examples 1-7, wherein the desired notification rate is based on a configurable error monitoring interval that controls the periodic error monitoring and a configurable initial value of the error counter.

Example 9 includes the subject matter of Examples 1-8, wherein the device comprises an integrated graphics processing unit (GPU).

Example 10 includes the subject matter of Examples 1-9, wherein the device comprises a discrete GPU.

Some embodiments pertain to Example 11 that includes a non-transitory machine-readable medium storing instructions, which when executed by a processor of a computer system cause the computer system to responsive to a burst of correctable errors reported by a device exceeding an error threshold: disable correctable error reporting for the device, wherein the device comprises a peripheral component interconnect express (PCIe) or a compute express link (CXL) device associated with the computer system; and cause a baseboard management controller (BMC) of the computer system to perform threshold-based error rate monitoring by issuing a notification to the BMC, wherein the threshold-based error rate monitoring, includes: decrementing an error counter in accordance with a leak rate; during periodic error monitoring, incrementing the error counter when a new correctable error has been logged by the device; and distinguishing between persistent and temporal errors associated with the device based on the error counter.

Example 12 includes the subject matter of Example 11, wherein the instructions further cause the computer system to responsive to the error counter exceeding a persistent error threshold, identify existence of a persistent error associated with the device.

Example 13 includes the subject matter of Examples 11-12, wherein the persistent error is predictive of an imminent uncorrectable error associated with the device.

Example 14 includes the subject matter of Examples 11-13, wherein the instructions further cause the computer system to responsive to the error counter falling to zero: identify the burst of correctable errors as the temporal error; and re-enable correctable error reporting for the device.

Example 15 includes the subject matter of Examples 11-14, wherein the burst of correctable errors are individually reported to a system management interrupt (SMI) handler of a basic input/output system (BIOS) running on the processor and wherein the instructions further cause the computer system to protect, by the SMI handler, against degradation of performance of the processor by said disabling correctable error reporting for the device.

Example 16 includes the subject matter of Examples 11-15, wherein the instructions further cause the computer system to limit notifications to an operating system of the computer system regarding correctable errors reported by the device to a desired notification rate based on a configurable error monitoring interval that controls the periodic error monitoring and a configurable initial value of the error counter.

Some embodiments pertain to Example 17 that includes a method comprising: responsive to a burst of correctable errors reported by a device exceeding an error threshold, disabling correctable error reporting for the device and issuing a notification to a baseboard management controller (BMC) of a computer system, wherein the device comprises a peripheral component interconnect express (PCIe) or a compute express link (CXL) device associated with the computer system; and responsive to receipt of the notification, performing, by the BMC, threshold-based error rate monitoring by: decrementing an error counter in accordance with a leak rate of a leaky bucket implemented by the BMC for the device; during periodic error monitoring for new correctable errors logged by the device, incrementing the error counter when a new correctable error has been logged by the device since a prior error monitoring interval; and distinguishing between persistent and temporal errors associated with the device based on the error counter.

Example 18 includes the subject matter of Example 17, further comprising responsive to the error counter exceeding a persistent error threshold, identifying existence of a persistent error associated with the device.

Example 19 includes the subject matter of Examples 17-18, wherein the persistent error is predictive of an imminent uncorrectable error associated with the device.

Example 20 includes the subject matter of Examples 17-19, further comprising responsive to the error counter falling to zero: identifying the burst of correctable errors as the temporal error; and re-enabling correctable error reporting for the device.

Example 21 includes the subject matter of Examples 17-20, wherein the burst of correctable errors are individually reported to a system management interrupt (SMI) handler of a basic input/output system (BIOS) running on the processor and the method further comprises protecting, by the SMI handler, against degradation of performance of the processor by said disabling correctable error reporting for the device.

Example 22 includes the subject matter of Examples 17-21, further comprising limiting notifications to an operating system of the computer system regarding correctable errors reported by the device to a desired notification rate based on a configurable error monitoring interval that controls the periodic error monitoring and a configurable initial value of the error counter.

Example 23 includes the subject matter of Examples 17-22, further comprising limiting notifications to an operating system of the computer system regarding correctable errors reported by the device to a desired notification rate based on a configurable error monitoring interval that controls the periodic error monitoring and a configurable initial value of the error counter.

Some embodiments pertain to Example 24 that includes an apparatus that implements or performs a method of any of Examples 17-22.

Some embodiments pertain to Example 25 includes an apparatus comprising means for performing a method as claimed in any of Examples 17-22.

Some embodiments pertain to Example 26 that includes at least one machine-readable medium comprising a plurality of instructions, when executed on a computing device, implement or perform a method or realize an apparatus as described in any preceding Example.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

1-22. (canceled)

23. A computer system comprising:
one or more processors;
a baseband management controller (BMC) coupled to the one or more processors; and
instructions that when executed by the one or more processors cause the computer system to, after a burst of correctable errors reported by a device exceeding an error threshold:
disable correctable error reporting for the device, wherein the device comprises a peripheral component interconnect express (PCIe) or a compute express link (CXL) device associated with the computer system; and
cause the BMC to perform threshold-based error rate monitoring by issuing a notification to the BMC, wherein the threshold-based error rate monitoring, includes:
during periodic error monitoring keeping track of when a correctable error has been logged by the device; and
distinguishing between persistent and temporal errors associated with the device based on the correctable errors.

24. The computer system of claim 23, wherein the threshold-based error rate monitoring further includes:
decrementing an error counter in accordance with a leak rate of a leaky bucket implemented by the BMC for the device; and
during periodic error monitoring for new correctable errors logged by the device, incrementing the error counter when a new correctable error has been logged by the device since a prior error monitoring interval.

25. The computer system of claim 24, wherein the instructions further cause the computer system to after the error counter exceeds a persistent error threshold, identify existence of a persistent error associated with the device.

26. The computer system of claim 25, wherein the persistent error is predictive of an imminent uncorrectable error associated with the device.

27. The computer system of claim 24, wherein the instructions further cause the computer system to after the error counter falls to zero:
identify the burst of correctable errors as the temporal error; and
re-enable correctable error reporting for the device.

28. The computer system of claim 23, wherein correctable errors of the burst of correctable errors are individually reported to a system management interrupt (SMI) handler of a basic input/output system (BIOS) running on the one or more processors and wherein the instructions further cause the computer system to protect, by the SMI handler, against degradation of performance of the one or more processors by disabling correctable error reporting for the device.

29. The computer system of claim 23, wherein the instructions further cause the computer system to limit notifications to an operating system of the computer system regarding correctable errors reported by the device to a desired notification rate.

30. The computer system of claim 29, wherein the desired notification rate is based on a configurable error monitoring interval that controls the periodic error monitoring and a configurable initial value of the error counter.

31. The computer system of claim 23, wherein the device comprises an integrated graphics processing unit (GPU).

32. The computer system of claim 23, wherein the device comprises a discrete GPU.

33. A non-transitory machine-readable medium storing instructions, which when executed by one or more processors of a computer system cause the computer system to after a burst of correctable errors reported by a device exceeding an error threshold:
disable correctable error reporting for the device, wherein the device comprises a peripheral component interconnect express (PCIe) or a compute express link (CXL) device associated with the computer system; and
cause a baseboard management controller (BMC) of the computer system to perform threshold-based error rate monitoring by issuing a notification to the BMC, wherein the threshold-based error rate monitoring, includes:
decrementing an error counter in accordance with a leak rate;
during periodic error monitoring, incrementing the error counter when a new correctable error has been logged by the device; and
distinguishing between persistent and temporal errors associated with the device based on the error counter.

34. The non-transitory machine-readable medium of claim 33, wherein the instructions further cause the computer system to after the error counter exceeds a persistent error threshold, identify existence of a persistent error associated with the device.

35. The non-transitory machine-readable medium of claim 34, wherein the persistent error is predictive of an imminent uncorrectable error associated with the device.

36. The non-transitory machine-readable medium of claim 33, wherein the instructions further cause the computer system to after the error counter falls to zero:
identify the burst of correctable errors as the temporal error; and
re-enable correctable error reporting for the device.

37. The non-transitory machine-readable medium of claim 33, wherein correctable errors of the burst of correctable errors are individually reported to a system management interrupt (SMI) handler of a basic input/output system (BIOS) running on the one or more processors and wherein the instructions further cause the computer system to protect, by the SMI handler, against degradation of performance of the one or more processors by said disabling correctable error reporting for the device.

38. The non-transitory machine-readable medium of claim 33, wherein the instructions further cause the computer system to limit notifications to an operating system of the computer system regarding correctable errors reported by the device to a desired notification rate based on a configurable error monitoring interval that controls the periodic error monitoring and a configurable initial value of the error counter.

39. A method comprising:
after a burst of correctable errors reported by a device exceeds an error threshold, disabling correctable error reporting for the device and issuing a notification to a baseboard management controller (BMC) of a computer system, wherein the device comprises a peripheral component interconnect express (PCIe) or a compute express link (CXL) device associated with the computer system; and
after receipt of the notification, performing, by the BMC, threshold-based error rate monitoring by:
decrementing an error counter in accordance with a leak rate of a leaky bucket implemented by the BMC for the device;
during periodic error monitoring for new correctable errors logged by the device, incrementing the error counter when a new correctable error has been logged by the device since a prior error monitoring interval; and
distinguishing between persistent and temporal errors associated with the device based on the error counter.

40. The method of claim 39, further comprising:
after the error counter exceeds a persistent error threshold, identifying existence of a persistent error associated with the device, wherein the persistent error is predictive of an imminent uncorrectable error associated with the device; and
after the error counter falls to zero:
identifying the burst of correctable errors as the temporal error; and
re-enabling correctable error reporting for the device.

41. The method of claim 39, wherein correctable errors of the burst of correctable errors are individually reported to a system management interrupt (SMI) handler of a basic input/output system (BIOS) running on the one or more processors and the method further comprises protecting, by the SMI handler, against degradation of performance of the one or more processors by said disabling correctable error reporting for the device.

42. The method of claim 39, further comprising limiting notifications to an operating system of the computer system regarding correctable errors reported by the device to a desired notification rate based on a configurable error monitoring interval that controls the periodic error monitoring and a configurable initial value of the error counter.
